(19) United States
(12) Patent Application Publication
(10) Pub. No.: US 2005/0079337 A1
(43) Pub. Date: Apr. 14, 2005

(54) Porous body and method of making the porous body

(75) Inventors: Takashi Hashida, Osaka (JP); Masaaki Suzuki, Osaka (JP); Kazuhiko Hashimoto, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/615,646

(22) Filed: Jul. 9, 2003

(30) Foreign Application Priority Data
Jul. 10, 2002 (JP) 2002-201404
Sep. 6, 2002 (JP) 2002-261591
Apr. 22, 2003 (JP) 2003-116884
May 9, 2003 (JP) 2003-131415

(51) Int. Cl. B32B 3/26

(52) U.S. Cl. 428/304.4; 264/41

(57) ABSTRACT

A method of making a porous body, including a dry gel, includes the step of forming the dry gel. The step of forming the dry gel includes the steps of: preparing a first gel having a first skeleton and pores; and restructuring the first gel by decomposing at least a portion of the first skeleton and forming a second skeleton, which is thicker than the first skeleton.

### BACKGROUND OF THE INVENTION

1. Field of the Invention

The present invention relates to a low-density porous body for use as a heat insulator, an acoustical material, a catalyst carrier, an interlevel dielectric for an LSI, or the material of an acoustic matching layer for an ultrasonic or other acoustic wave transceiver, and also relates to a method of making such a porous body.

2. Description of the Related Art

Low-density porous bodies have a relatively low density, a relatively large specific surface, a microporous structure, a relatively low dielectric constant, and a relatively low acoustic impedance, and are often used as heat insulators, acoustical materials, catalyst carriers, interlevel dielectric for LSIs, and materials of acoustic matching layers for ultrasonic wave transceivers.

For example, when such a low-density porous body is used as a heat insulator, the solid has decreased heat conduction due to the relatively low density thereof. Also, such a material has a microporous structure, and can exhibit excellent adiabatic performance. The adiabatic performance of such a material can be further increased by encapsulating the material within a reduced-pressure container. The heat insulator of this type may be used for heat insulation purposes in consumer electronic appliances (e.g., heaters) or building materials.

When the porous body is used as a heat insulator or for any other purpose, the porous body may be shaped into a block or membrane of a pure porous body, including substantially no impurities, and then either inserted into, or directly formed on, a required portion. Alternatively, the porous body may also be used in the form of a powder or particles to fill a container with, for example. As another alternative, such porous body powder or particles may also be combined with an inorganic or organic binder and then the mixture may be compacted into a block. A filler such as a fiber material is sometimes further added to such a block or powder compact for strengthening purposes. A dry gel is known as an exemplary porous body. A porous body may either consist. essentially of a dry gel or a mixture of a dry gel, a binder and/or a filler. As used herein, the “dry gel” is a porous body to be formed by a sol-gel process. Specifically, the dry gel is obtained by performing the process steps of: preparing a gel raw material solution; forming a wet gel with a solvent by getting the skeleton solidified through reaction of the gel raw material solution; and then drying the wet gel by removing the solvent.

The wet gel and the dry gel have very small pore diameters. Accordingly, while the wet gel is being dried to remove the solvent therefrom and obtain the dry gel or when the dry gel obtained is exposed to an organic solvent, a capillary force is produced due to the presence of a gas-liquid interface inside the pores. This capillary force is inversely proportional to the pore diameter. Due to such capillary force, the gel shrinks. And while the gel is shrinking, hydroxide groups are bonded together on the surface as a result of a hydrogen bond formation, for example. Thus, the shrunken state is defined and the dry gel has an increased density as a result. Also, during such shrinkage action, the dry gel may crack or chip due to the stress.

If these problems happen during the dry gel manufacturing process, then no desired dry gels can be obtained. Also, if such problems happen after a dry gel has been manufactured, then the dry gel should exhibit deteriorated performance. For example, if a porous body including such a deteriorated dry gel (i.e., with an excessively increased density and with gaps created by cracking) is used as a heat insulator, the heat insulator will have an increased thermal conductivity or cause leakage of heat, thus resulting in decreased heat insulation performance. On the other hand, if such a bad porous body is used in an acoustic matching layer, then the acoustic wave is transmitted at an unintentionally increased velocity and with a decreased efficiency. Also, if the cracked porous body peels off the undercoat material, the acoustic wave will also be transmitted or received with a significantly decreased efficiency. Likewise, when such a porous body is used as an acoustical material, the unwanted increase in the density of the porous body will decrease the acoustic absorptivity from its initial setting.

Thus, to minimize the unwanted increase in density or cracking of the dry gel being manufactured, Japanese Laid-Open Publication No. 7-138375 discloses a method of drying the wet gel by a supercritical drying technique without producing any capillary force. Also, to minimize the unwanted increase in the density of the dry gel, Japanese Laid-Open Publication No. 7-138375 and Journal of Non-Crystalline Solids, vol. 186, pp. 104-122, 1995 disclose a method of reducing the number of hydroxide groups on the surface of the (skeleton of a) dry gel by modifying the surface of the dry gel having a metal oxide skeleton with an organic silyl group and hydrophobizing the surface.

In the method disclosed in Japanese Laid-Open Publication No. 7-138375, alkoxysilane, which is a metal alkoxide, is used as a material. By performing a sol-gel process on this material, a wet gel including an alcohol solvent is obtained. Then, water remaining in the wet gel is removed by substituting alcohol for the water. Thereafter, in supercritical carbon dioxide, the surface of the wet gel is exposed to a silylation reagent (i.e., a hydrophobizing agent), thereby introducing an organic silyl group into the surface and hydrophobizing the surface. Finally, a supercritical drying process is carried out by removing the carbon dioxide at a critical temperature or a higher temperature. The dry gel obtained in this manner is a porous body, of which the skeleton is made of a silicon oxide and of which the surface includes the organic silyl group.

In the method disclosed in Journal of Non-Crystalline Solids, vol. 186, pp. 104-122, 1995, a wet gel is obtained and the water remaining in the wet gel is replaced with alcohol as in Japanese Laid-Open Publication No. 7-138375. In this method, however, the hydrophobization process is carried out by exposing the surface of the wet gel to a silylation reagent in a hydrocarbon solvent and introducing an organic silyl group into the surface. Then, the wet gel is dried by heating and vaporizing the solvent from the wet gel. In this manner, a dry gel, of which the skeleton is made of a silicon oxide and of which the surface includes the organic silyl group, can be obtained.

On the other hand, WO 92/20623 discloses that an alkogel is formed by subjecting tetraalkoxysilane to hydrolysis and condensation polymerization processes and then exposed to a tetra-alkoxysilane solution, thereby strengthening the skeleton of the alkogel.

However, the present inventors discovered and confirmed via experiments that when a gel with as low a density as about 50 kg/M³ to about 150 kg/M³ was formed by the method disclosed in Japanese Laid-Open Publication No. 7-138375 or Journal of Non-Crystalline Solids, vol. 186, pp. 104-122, 1995, the gel had too low a mechanical strength to minimize the unwanted increase in the density of the gel during drying the wet gel that had been obtained by substituting an organic solvent (such as alcohol or a hydrocarbon solvent) for the water of the wet gel.

Also, when a dry gel with a density higher than about 150 kg/m³ and equal to or lower than about 500 kg/m³ was formed by the conventional method, the gel had a relatively high mechanical strength. Thus, while the wet gel, in which the water had been replaced with an organic solvent, was being dried or while the dry gel was being dried again after having been exposed to the organic solvent, no increase in density was sometimes observed. However, while the dry gel was being dried after having been exposed to the organic solvent, the capillary force was produced to cause a shrinkage stress. Thus, it was difficult to avoid cracking resulting from the shrinkage (i.e., the collapse of the gel skeleton).

Furthermore, even when the method disclosed in WO 92/20623 was adopted, the skeleton of the dry gel could not be strengthened sufficiently. Thus, it was difficult to avoid the collapse of the skeleton of a dry gel with a density of about 500 kg/m³ or less.

### SUMMARY OF THE INVENTION

In order to overcome the problems described above, preferred embodiments of the present invention provide a porous body including a dry gel, which hardly shrinks or cracks even when exposed to an organic solvent, and a method of making such a porous body.

A method of making a porous body including a dry gel according to a preferred embodiment of the present invention preferably includes the step of forming the dry gel. The step of forming the dry gel preferably includes the steps of: preparing a first gel having a first skeleton and pores; and restructuring the first gel by decomposing at least a portion of the first skeleton and forming a second skeleton, which is thicker than the first skeleton.

In one preferred embodiment of the present invention, the step of restructuring preferably includes the step of exposing the first gel to a restructuring material solution that produces particles with particle sizes of about 10 nm to about 100 nm.

In another preferred embodiment, the step of preparing the first gel preferably includes the step of deriving a first wet gel from a first gel raw material solution by a sol-gel process. The first gel raw material solution preferably includes a first gel raw material, a first catalyst and a first solvent.

In this particular preferred embodiment, the step of restructuring preferably includes the step of exposing the first wet gel to a restructuring material solution, which includes a restructuring material, a restructuring catalyst, water and a restructuring solvent.

More specifically, the step of restructuring preferably includes the step of producing particles with particle sizes of about 10 nm to about 100 nm in the restructuring material solution.

In still another preferred embodiment, the method preferably further includes the step of decomposing a portion of the second skeleton and strengthening the second skeleton by exposing a second wet gel, produced by the restructuring step, to an aqueous solution including another catalyst.

In yet another preferred embodiment, the method preferably further includes the step of hydrophobizing the surface of the second skeleton.

In this particular preferred embodiment, the step of hydrophobizing the surface of the second skeleton and the step of restructuring are preferably carried out in parallel with each other.

In yet another preferred embodiment, the step of forming the dry gel preferably includes the step of forming a hydrophilic dry gel.

It should be noted that the restructuring step according to the preferred embodiment of the present invention includes gelation to be produced in the restructuring material solution, which is prepared separately from the first gel raw material solution, and will be sometimes referred to herein as a “second gelation process step”. Also, the restructuring material, the restructuring catalyst and the restructuring solvent will be sometimes referred to herein as a “second gel raw material”, a “second catalyst” and a “second solvent”, respectively.

A porous body according to a preferred embodiment of the present invention is preferably made by the method according to any of the preferred embodiments of the present invention described above.

In one preferred embodiment, the dry gel preferably has a skeleton and pores. The pores preferably include a first group of pores with pore diameters of about 2 nm to about 40 nm. The first group of pores preferably has a volume of at most about 1 cm³/g.

A porous body according to another preferred embodiment of the present invention preferably includes a dry gel having a skeleton and pores. The pores preferably include a first group of pores with pore diameters of about 2 nm to about 40 nm, and the first group of pores preferably has a volume of at most about 1 cm³/g.

In one preferred embodiment of the present invention, the dry gel preferably has the first group of pores with a volume of at most about 0.5 cm³/g and with a specific surface of at most about 300 m²/g.

In another preferred embodiment, the surface of the skeleton is preferably hydrophilic.

In still another preferred embodiment, at least one surface portion of the porous body preferably has a higher density than the other surface portions thereof.

In yet another preferred embodiment, the dry gel preferably has an average density of about 50 kg/M³ to about 500 kg/m³.

In yet another preferred embodiment, the skeleton of the dry gel is preferably made of an inorganic material.

In this particular preferred embodiment, the inorganic material preferably includes an inorganic oxide.

In yet another preferred embodiment, the dry gel does not crack even when heated and dried after having been immersed in n-hexane.

A composite body according to a preferred embodiment of the present invention preferably includes a base and a porous body layer provided on the base. The porous body layer preferably includes the porous body according to any of the preferred embodiments of the present invention described above.

A gel raw material solution according to a preferred embodiment of the present invention is preferably used as the restructuring material solution according to the preferred embodiment described above. The gel raw material solution preferably includes a gel raw material, a catalyst, water and a solvent.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic representation showing respective process steps for making a dry gel according to a preferred embodiment of the present invention.

FIGS. 2A and 2B respectively illustrate schematically the first skeleton of a first wet gel and the second skeleton of a second wet gel, obtained by a restructuring process step, in a dry gel manufacturing process according to a preferred embodiment of the present invention.

FIGS. 3A through 3E are graphs showing the particle size distributions of particles that were produced in a restructuring material solution representing a first specific example of a preferred embodiment of the present invention.

FIG. 4A is a graph showing cumulative pore volume curves (each showing a relationship between the pore volume (cm³/g) and the pore diameter (nm)) that were obtained for respective dry gels by a BJH method.

FIG. 4B is a graph showing differential pore volume curves.

FIG. 5A is a schematic perspective view showing a flat plate porous body made of a dry gel according to a preferred embodiment of the present invention.

FIG. 5B is a graph schematically showing a density distribution in the porous body.

FIGS. 6A, 6B and 6C schematically illustrate three composite bodies, each including a porous body made of a dry gel according to a preferred embodiment of the present invention and a base.

### DETAILED DESCRIPTION OF PREFERRED EMBODIMENTS

Hereinafter, preferred embodiments of the present invention will be described with reference to the accompanying drawings.

First, a method of making a porous body including a dry gel according to a preferred embodiment of the present invention will be described. The following preferred embodiment is a method of making a dry gel with a density of about 500 kg/m³ or less because the effects of the present invention are achieved particularly remarkably in that case. However, it is naturally possible to make a dry gel with a density exceeding about 500 kg/m³ by the manufacturing process of the present invention.

In the method of making a porous body including a dry gel according to a preferred embodiment of the present invention, the step of forming the dry gel preferably includes the steps of: preparing a first gel having a first skeleton and pores; and restructuring the first gel by decomposing at least a portion of the first skeleton and forming a second skeleton, which is thicker than the first skeleton. The restructuring step will be sometimes referred to herein as a “second gelation step”. The first gel may be prepared by a known process.

The restructuring step is preferably carried out as the process step of exposing the first gel to a restructuring material solution, which produces particles with particle sizes of about 10 nm to about 100 nm. The restructuring material solution will be sometimes referred to herein as a “second gel raw material solution”.

The step of preparing the first gel may be carried out by a known method, which may include the process step of deriving a first wet gel from a first gel raw material solution by a sol-gel process. The first gel raw material solution preferably includes a first gel raw material, a first catalyst (i.e., a gelation catalyst) and a first solvent. The process step of forming the first wet gel will be sometimes referred to herein as a “first gelation process step”. In this process step, a wet gel, which will have a density of at most about 500 kg/m³ when dried, is prepared.

The restructuring material solution (i.e., a second gel raw material solution), to which the first gel is exposed in the restructuring process step, preferably includes a restructuring material (second gel raw material), a restructuring catalyst (second catalyst), water, and a restructuring solvent (second solvent). The restructuring material may be the same as the first gel raw material, and the restructuring catalyst may be the same as the first catalyst. The restructuring material solution needs to include water and preferably produces particles with particle sizes of about 10 nm to about 100 nm.

The first gel to be exposed to the restructuring material solution is preferably a wet gel (i.e., first wet gel). When the wet gel, which will have a density of at most about 500 kg/m³ when dried as described above, is dried, the gel may crack during the drying process. However, if the wet gel is exposed as it is to the restructuring material solution, then the wet gel will not increase its density or crack due to the collapse of its skeleton, even though the first gel has a low density. It should be noted that if the resultant dry gel is used as a powder (or granules), then the wet gel may be once dried and then subjected to the restructuring process step. In that case, the surface of the skeleton of the first gel is preferably hydrophobized. This hydrophobization process may be carried out by a known method.

This restructuring process step does not have to be completed just once but may be carried out a number of times step by step. Optionally, a gel strengthening process step may also be carried out. Specifically, a second wet gel, obtained by the restructuring process step, may be exposed to an aqueous solution including a third catalyst to decompose a portion of the second skeleton and strengthen the second skeleton.

Also, the method of this preferred embodiment may further include the step of hydrophobizing the surface of the resultant second skeleton. This hydrophobizing process step may be carried out either after the restructuring process step or in parallel with the restructuring process step. The hydrophobizing process step may be naturally carried out after the second wet gel with the second skeleton, obtained by the restructuring process step, has been dried.

Hereinafter, it will be described exactly how the desired dry gel, which hardly shrinks or cracks even when exposed to an organic solvent, is obtained by the method for making a dry gel according to this preferred embodiment.

First, the skeleton of a wet gel with a relatively low density (e.g., at most about 500 kg/M³ when dried) is formed (or defined) by the first gelation process step. Next, in the restructuring (i.e., second gelation) process step, fine particles, obtained by polymerizing a monomer or an oligomer in the restructuring material (i.e., the second gel raw material) solution, are mainly condensed with the first skeleton (defined by the first gelation process step), thereby strengthening relatively thin portions of the first skeleton to form a second skeleton, which is thicker than the first skeleton, and increasing the density. In this manner, according to this preferred embodiment, after the skeleton of a gel has been once defined by a gelation process step, the gel is subjected to another gelation process step. Thus, the density of the gel can be increased sufficiently even while the gel is still in a wet gel state. As a result, a dry gel having a desired high density, which has not been realized by any conventional process so far, can be provided by this preferred embodiment of the present invention.

Meanwhile, in the restructuring process step, while the density is increasing due to the polymerization and the condensation, the first skeleton is also being decomposed (i.e., dissolved). That is to say, the hydrolysis of the first skeleton is produced in parallel with the polymerization due to the presence of the water and the restructuring catalyst (i.e., second catalyst) in the restructuring material solution. As a result, the micro-porous structure of the first gel disappears and instead a gel structure having a second skeleton, which is thicker than the first skeleton, and relatively large pores is newly formed by the restructuring.

In addition, according to the manufacturing process of this preferred embodiment of the present invention, the shrinkage of the wet gel, which normally occurs during a gelation process step, can be minimized. Accordingly, when a dry gel is formed on a base, for example, the dry gel will hardly crack or drop off the base. The reason is as follows.

Normally, in a gelation process step, the higher the initial density of a gel, the more significant its shrinkage caused by cross-linking. However, the dry gel manufacturing process of this preferred embodiment includes the first gelation process step and the restructuring process step. Accordingly, the density of the gel to be obtained by the first gelation process step, which is performed to obtain a gel with a certain density, can be decreased. As a result, the shrinkage to be caused by the first gelation process step can be reduced.

It is known that the first wet gel can also be strengthened by a conventional aging treatment in which the first wet gel is left at a predetermined temperature in the first gel raw material solution without adding any gel raw material thereto. It is believed that in this conventional aging treatment, dehydration and condensation reactions advance between hydroxide groups in relatively thin portions of the first skeleton, thus strengthening the bond and the gel itself eventually. In that case, however, since no additional gel raw material is supplied, the skeleton cannot be thickened sufficiently and the strength cannot be increased fully.

On the other hand, in the method disclosed in WO 92/20623, the additional gel raw material is supplied in the aging treatment, and the aging treatment does contribute to increasing the strength to a certain degree. However, even after the aging treatment is finished, most of the micropores with very small diameters of about 2 nm to about 40 nm are still left. Thus, the gel is not yet strong enough to avoid shrinking or cracking when exposed to an organic solvent or when dried after that.

The reason is that since the initially defined gel skeleton (i.e., first skeleton) is decomposed by none of these conventional methods, micropores are left as they are and the capillary force produced inside of those pores is not reduced at all.

Hereinafter, specific preferred embodiments of the manufacturing process of the present invention will be described.

### Embodiment 1

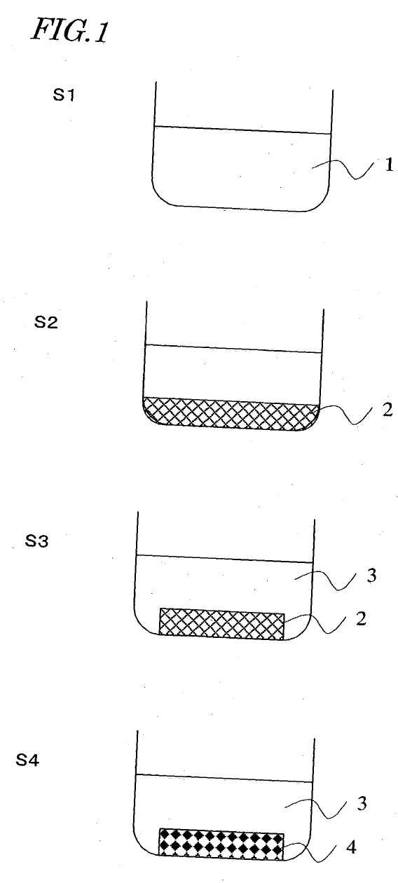

As shown in FIG. 1, a method of making a porous body, including a dry gel, according to a first specific preferred embodiment of the present invention preferably includes the steps S1 through S4. The first step S1 is the process step of preparing a first gel raw material solution 1 including a first gel raw material, a first catalyst and a first solvent. The second step S2 is the process step of forming a first wet gel 2 out of the first gel raw material solution 1. The third step S3 is the process step of exposing the first wet gel 2 to a separately prepared restructuring material solution 3 including a restructuring material, a restructuring catalyst, water and a restructuring solvent. The fourth step S4 is the process step of forming a second wet gel 4, having a second skeleton that is thicker than the first skeleton of the first wet gel 2, in the restructuring material solution 3. Although not shown in FIG. 1, the second wet gel 4 is hydrophobized by performing the hydrophobizing process step after the fourth step S4 and then dried, thereby obtaining a dry gel that hardly shrinks or cracks even when exposed to an organic solvent. As will be described later, the dry gel obtained in this manner is characterized in that the pores thereof with pore diameters of about 2 nm to about 40 nm have a volume of at most about 1 cm³/g.

As used herein, the “pore volume” is supposed to be calculated by applying a BJH method to a nitrogen adsorption process and the “specific surface” is supposed to be calculated by applying a BET method to a nitrogen adsorption process unless otherwise stated.

Hereinafter, the respective process steps will be described in further detail.

### First Gelation Process Step

In this preferred embodiment, first, the first wet gel 2 is formed by a so-called sol-gel process (i.e., by performing the steps S1 and S2 shown in FIG. 1). In this process step, the gelation is advanced by adding a first catalyst (i.e., a gelation catalyst) to a first gel raw material.

The gel raw material for use in the manufacturing process of this preferred embodiment may be a normal material for use in a sol-gel process. Examples of such gel raw materials include oxide fine particles and alkoxides of silicon, aluminum, zirconium and titanium, for example. Among other things, a compound including silicon as a metal is particularly preferred because such a material is easily available. When a metal alkoxide is used, the metal alkoxide also preferably includes silicon because its reaction is easily controllable. Examples of preferred materials include tetraalkoxysilanes such as tetramethoxysilane and tetraethoxysilane and other silicon alkoxides such as trialkoxysilane and dialkoxysilane.

Among these materials, dialkoxysilane is preferably used after having been mixed with another gel raw material, because it is difficult to form a gel by dialkoxysilane alone. Optionally, if the oligomer of any of these materials is used as a gel raw material, then such a gel raw material will have a higher boiling point and the manufacturing process can have increased safety. Other alternative preferred materials include colloidal silica, water glass and silicate solutions obtained by performing an electrodialysis on water glass, because these materials are relatively inexpensive.

Examples of preferred gelation catalysts include normal organic acids, inorganic acids, organic bases and inorganic bases. The organic acid may be acetic acid or citric acid, for example. The inorganic acid may be sulfuric acid, hydrochloric acid or nitric acid, for example. The organic base may piperidine, for example. And the inorganic base may be ammonium, for example. An imine such as piperidine is preferably used to reduce the capillary force because such a material has a relatively large pore diameter.

Examples of preferred first solvents include aqueous organic solvents such as lower alcohols including methanol, ethanol, propanol, butanol, ethyleneglycol and diethylene glycol, lower ketones including mono- or diethers of ethyleneglycol and diethyleneglycol and acetones, and lower ethers including tetrahydrofuran and 1,3-dioxolane. Also, if a gel is formed by the hydrolysis and condensation polymerization reactions of the first gel raw material, water, required for the hydrolysis process, is further added.

### Restructuring Process Step

The first gelation process step is followed by the restructuring process step (i.e., the steps S3 and S4 shown in FIG. 1). In the restructuring process step, the skeleton of the first wet gel 2, obtained by the first gelation process step, is decomposed partially, while at the same time, a new skeleton (i.e., the second skeleton of the second wet gel 4) is also formed. Specifically, first, in the step S3, the restructuring material solution 3 is prepared by mixing together the restructuring material, restructuring catalyst, water and solvent (if necessary) to perform the restructuring process step, and then the first wet gel 2 obtained by the first gelation process step is immersed in the restructuring material solution 3.

By adding the restructuring catalyst, the polymerization and the condensation can be advanced and the growth of the new skeleton can be accelerated. Also, the water and restructuring catalyst added function in such a manner as to decompose (or dissolve) the fine particles that make up the skeleton of the first wet gel 2 and collapse the micro-porous structure of the first wet gel 2 through the hydrolysis reaction. This hydrolysis reaction is also accelerated by the restructuring catalyst. In this manner, the rate at which the old skeleton (i.e., the first skeleton) is decomposed and the rate at which the new skeleton (i.e., the second skeleton) is formed are both very high, thus realizing such skeleton restructuring involving the significant change of the porous structure.

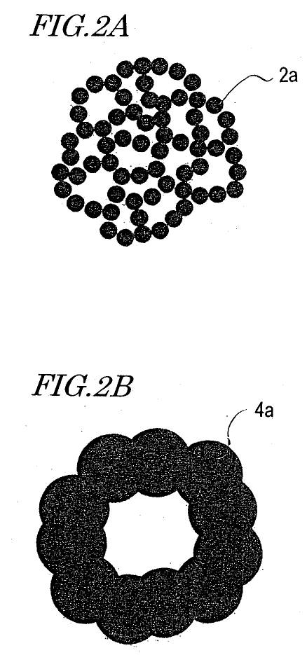

Next, it will be described with reference to FIGS. 2A and 2B how the skeleton of the wet gel is restructured through the acceleration reaction. FIG. 2A schematically illustrates the first skeleton 2a of the first wet gel 2, while FIG. 2B schematically illustrates the second skeleton 4a of the second wet gel 4 obtained by this preferred embodiment of the present invention. The skeletons 2a and 4a schematically illustrated in FIGS. 2A and 2B were drawn after the SEM photographs of dry gels that were obtained by specific examples of the present invention to be described later.

The first skeleton 2a shown in FIG. 2A is made up of particles with particle sizes of several nanometers. In this first skeleton 2a, the pores having pore diameters of about 2 nm to about 40 nm have an overall volume of about 3 cm³/g to about 5 cm³/g. In the conventional dry gel manufacturing process, this wet gel is hydrophobized and then dried. However, since this wet gel has quite a lot of micropores, the resultant dry gel often shrinks or cracks as described above. That is to say, it is difficult for the conventional process to obtain a dry gel having the structure shown in FIG. 2A.

In contrast, the second skeleton 4a of the second wet gel 4, obtained by this preferred embodiment of the present invention, is mainly composed of particles with particle sizes of about 10 nm to about 100 nm as a result of the partial decomposition of the first skeleton 2a and bonding of very small particles produced by the polymerization of the restructuring material. In the second skeleton 4a, the overall volume of micropores with pore diameters of about 2 nm to about 40 nm decreases drastically to about 1 cm³/g or less. Accordingly, even if the second wet gel 4 is dried after the restructuring process step, the resultant dry gel will hardly shrink or crack. Also, since the number of those micropores, which normally cause the unwanted shrinkage when a dry gel is immersed in an organic solvent or when the wet gel is dried, can be reduced significantly in this manner, the shrinkage or cracking of the dry gel being exposed to the organic solvent can also be minimized.

This phenomenon will be described in further detail based on the experimental data collected by the present inventors.

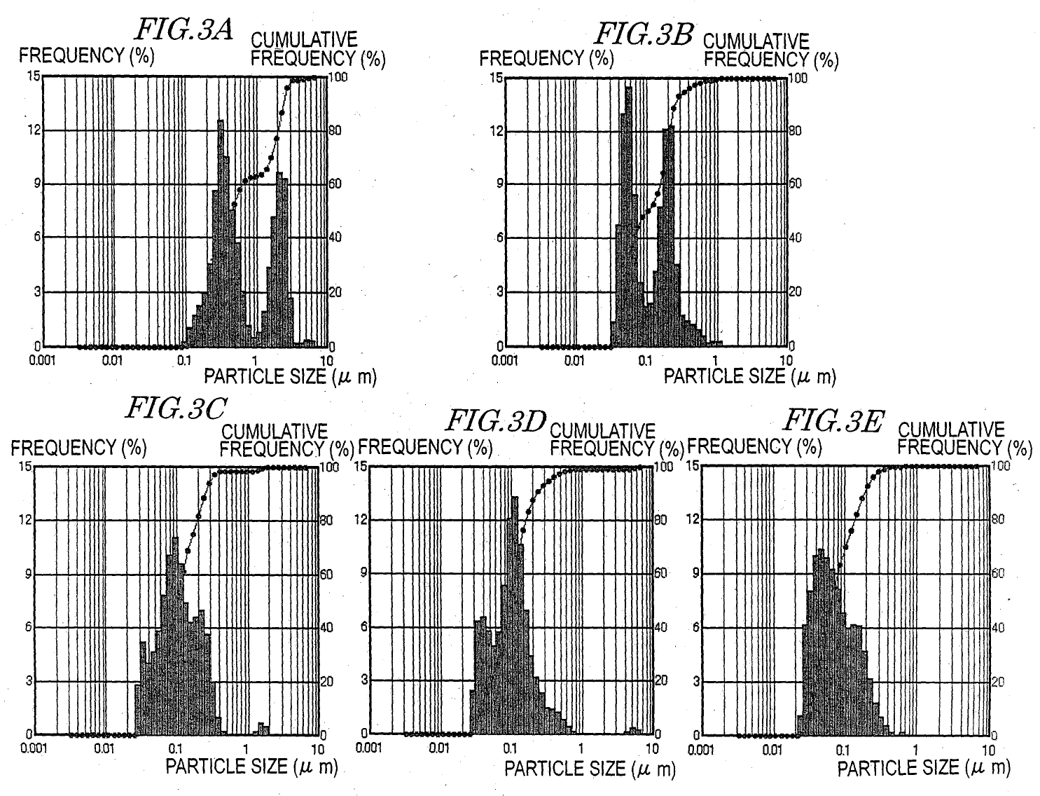

FIGS. 3A through 3E are graphs showing the particle size distributions of particles that were produced in the restructuring material solution (having the same composition as the second specific example of the present invention to be described later). These particle size distributions were obtained by a dynamic scattering method. That is, the Doppler shifts of particles under Brownian movement were measured by using a particle size analyzer MICROTRAC UPA 150 (produced by Nikkiso Co., Ltd). Specifically, the results shown in FIGS. 3A, 3B, 3C, 3D and 3E were obtained after the solution prepared was left for approximately 1, 5, 10, 24 and 48 hours. It should be noted that no reliable data could be obtained until approximately one hour passed since the solution had been prepared, because the amount of particles was still relatively small and the scatter intensity was relatively low until then.

As can be seen from the results shown in FIGS. 3A through 3E, particles with sizes of about 30 nm to about 100 nm were produced in this restructuring material solution in approximately several to ten hours later. It should be noted that relatively large particles were produced in the first several hours and then a huge number of relatively small particles were produced with time. This is probably because non-uniform reactions must have happened during the first several hours. It is also imaginable that the gross particles once formed should have been decomposed with the passage of time.

If the first wet gel is immersed in such a solution, then relatively small particles with high reactivity (i.e., a large specific surface) are condensed or polymerized with the skeleton of the first gel preferentially among those particles with sizes of about 30 nm to about 100 nm that are present in the restructuring material solution. In parallel with the condensation and the polymerization, monomers or oligomers are dissolved off the first skeleton as a result of the hydrolysis reaction, thus restructuring the skeleton gradually.

The present inventors discovered and confirmed via experiments that the sizes of particles contributing to the condensation change with the specific particle size distribution of the solution including those particles. For example, when similar numbers of particles with sizes of around 10, 20, 30, 40 and 50 nm were distributed almost uniformly, the restructured gel consisted essentially of relatively small highly reactive particles with sizes of about 10 nm to about 20 nm. On the other hand, when similar numbers of particles with sizes of around 40 through 100 nm were distributed almost uniformly, relatively small particles with sizes of about 40 nm to about 60 nm mainly contributed to the condensation. Thus, to achieve the restructuring efficiently, a gel raw material solution that produces particles with particle sizes of about 10 nm to about 100 nm is preferably used as the restructuring material solution.

Generally speaking, the greater the sizes of the particles included the lower the reactivity of condensation and other reactions and the weaker the bond between the particles. In the manufacturing process of this preferred embodiment, however, particles with sizes of about 10 nm to about 100 nm are polymerized (or condensed) with (i.e., bonded to the surface of) the first skeleton on being produced in the restructuring solution. That is to say, the particles produced react to the first skeleton while exhibiting high reactivity (i.e., chemical activity) on the surface thereof. Thus, the condensation and other reactions advance quickly. Furthermore, a neck between the particles that make up the first skeleton is also highly active chemically and has a high degree of deformability. Accordingly, such a neck is often thickened particularly, thus strengthening the bond between the particles advantageously.

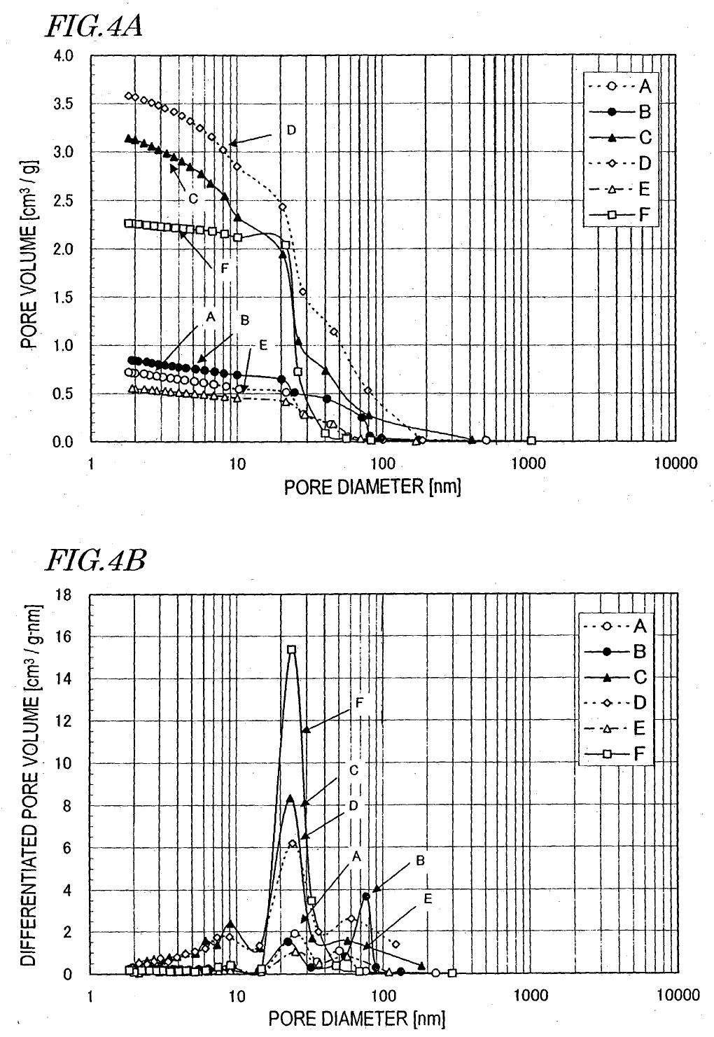

Next, it will be described with reference to FIGS. 4A and 4B how a second wet gel with relatively large pore diameters are formed by the restructuring process step. FIG. 4A is graph showing cumulative pore volume curves (each showing a relationship between the pore volume (cm³/g) and the pore diameter (nm)) that were obtained by a BJH method using a nitrogen gas, while FIG. 4B is a graph showing differential pore volume curves. In FIGS. 4A and 4B, the curves C and D represent the cumulative and differential pore volume curves of the first wet gel (after having been dried) while the curves A and B represent the cumulative and differential pore volume curves of the second wet gel (after having been dried) that had gone through the restructuring process step of this preferred embodiment. The other curves F represent the cumulative and differential pore volume curves of a wet gel (after having been dried) that had been obtained by strengthening the skeleton of the first wet gel by the method disclosed in WO 92/20623.

As can be seen from FIGS. 4A and 4B, the micropores with pore diameters of about 2 nm to about 40 nm included in the first wet gel (represented by the curves C and D) had a pore volume of about 3 cm³/g or more. However, after having gone through the restructuring process step of this preferred embodiment, the micropores had its pore volume decreased to about 1 cm³/g or less as can be seen from the curves A, B and E. In the sample represented by the curve E, in particular, the pore volume decreased to about 0.4 cm³/g or less.

The volume of the micropores decreased as a result of the restructuring process step. This is believed to be because a portion of the first skeleton should have been decomposed as a result of the hydrolysis reaction.

According to the method disclosed in WO 92/20623 on the other hand, the micropores with pore diameters of about 2 nm to about 40 nm had a volume of about 2 cm³/g or more and the first skeleton was neither decomposed nor restructured.

Furthermore, if the process time of the restructuring process step is extended or if the concentration(s) of the catalyst and/or water is/are increased, then the pore volume can be further reduced to about 0.5 cm³/g or less. As a result, the specific surface also decreases to about 300 m²/g or less.

This is the structure of a porous body that is made of a dry gel according to a preferred embodiment of the present invention. In this case, the wet gel neither shrinks even when exposed to an organic solvent nor cracks even after dried. Also, a porous body, made of a block of non-cracked and non-shrunken dry gel, can be obtained just as intended by heating and drying the restructured wet gel by a normal technique, not by the supercritical drying technique.

Also, the number of functional groups remaining (i.e., functional groups that have not been consumed for gelation) in the dry gel of this preferred embodiment is approximately several tens percent smaller than the conventional dry gel. For example, as shown in the following Table 1, when the first gel was made of alkoxysilane, the number of functional groups (including alkoxy groups and silanol groups) remaining in the restructured dry gel of this preferred embodiment was half of the number of functional groups remaining in the conventional dry gel. It should be noted that the dry gels shown in Table 1 had both been hydrophobized with dimethyldimethoxysilane and that the number of atoms with the functional groups were obtained by a ²⁹Si-NMR method.

TABLE 1

| | The number of Si | The number of Si |
|---|---|---|
| | atoms with no | atoms with |
| | Functional groups | Functional groups |
| Conventional | 100 | 54 |
| Dry gel | | |
| Dry gel of this | 100 | 27 |
| Preferred | | |
| embodiment | | |

Specifically, the conventional dry gel included TMOS as a gel raw material, used dimethyldimethoxysilane as a hydrophobizing agent, and had a density of about 0.21 g/cm³. On the other hand, the dry gel of this preferred embodiment included TEOS as a gel raw material, used dimethyldimethoxysilane as a hydrophobizing agent, and had a density of about 0.38 g/cm³.

Generally speaking, in a gel made of alkoxysilane, the skeleton thereof is made up of small particles, and there are a large number of functional groups, not contributing to the polymerization reaction, on the surface of the particles. In the manufacturing process of this preferred embodiment, the new skeleton is mainly composed of particles with sizes of about 10 nm to about 100 nm that have been produced in the restructuring gel raw material solution. That is to say, those particles are bonded to the surface of the skeleton of the first gel, thus decreasing the surface area of the gel and the number of functional groups remaining on the surface. When the dry gel of this preferred embodiment was observed with an SEM, the presence of particles with sizes of about 10 nm to about several tens nanometers on the surface of the skeleton was confirmed.

Also, depending on the concentrations of the restructuring catalyst and water to be added, the restructuring process can be advanced sufficiently even at room temperature or less. Thus, the manufacturing process of this preferred embodiment can be used particularly effectively if any material or component with poor heat resistance needs to be used.

Furthermore, the restructuring process should be advanced selectively on the skeleton of the wet gel obtained by the first gelation process step, not outside of the wet gel. For that purpose (i.e., to allow a sufficient amount of restructuring gel raw material to enter the first wet gel), the gelation process step is preferably completed in a relatively long time. Alternatively, to allow the restructuring gel raw material to enter the wet gel in a sufficiently short time, the wet gel preferably has a small fragment or particle shape or a thin film shape.

As already described, if a low-density gel skeleton is defined in an initial stage, then the resultant dry gel will shrink to a much lesser degree and will hardly crack due to shrinkage or drop off the base. Thus, when such a dry gel is used as a heat insulator, an acoustical material, a dielectric material or a material for an acoustic matching layer, the dry gel can exhibit good performance and significantly reduced variation in characteristics. Also, a porous body made of such a dry gel has an increased pore diameter. Accordingly, even when the dry gel happens to be exposed to an organic solvent, the cracking or shrinkage of the gel being dried can be reduced significantly. As a result, such a dry gel can be used with increased reliability.

The restructuring catalyst for use in the restructuring process step may be selected from the group of preferred gelation catalysts for use in the first gelation process step but does not have to be the same as the gelation catalyst used in the first gelation process step.

In the same way, the restructuring gel raw material for use in the restructuring process step may be the same as the first gel raw material used in the first gelation process step but the relationship between the first gel raw material and the restructuring gel raw material is not particularly limited. For example, if tetraethoxysilane, which is an alkoxysilane, is used as a gel raw material in the first gelation process step, tetraethoxysilane may be naturally used as the restructuring gel raw material in the restructuring process step. However, by selecting an appropriate solvent in which the gel raw material can be dissolved, any other metal alkoxide or an aqueous solution of silicate may also be used.

The solvent for use in the restructuring process step is not particularly limited, either, as long as the restructuring gel raw material and the restructuring catalyst can be dissolved in the solvent as described above.

### Hydrophobizing Process Step

The restructuring process step is followed by a hydrophobizing process step. In the hydrophobizing process step, a hydrophobizing agent, dissolved in a solvent, is reacted with the surface of the wet gel that was prepared before the restructuring process step, thereby introducing a hydrophobic group into the surface. If a chlorosilane is used as the hydrophobizing agent as will be described later, then the hydrophobizing agent reacts with water, thereby decreasing its reactivity with the surface of the wet gel. Accordingly, in that case, before the hydrophobizing process step is started, the water is preferably either removed by cleaning the wet gel with an aqueous solvent or boiled away with a solvent exhibiting azeotropy when mixed with water.

The hydrophobizing agent for use in this preferred embodiment of the present invention is preferably a silylation reagent considering its high reactivity. Examples of preferred silylation reagents for use in this preferred embodiment include silazane compounds, chlorosilane compounds, alkylsilanol compounds and alkylalkoxysilane compounds.

If a silazane compound, a chlorosilane compound or an alkylalkoxysilane compound is used as the silylation reagent, then the compound turns into a corresponding alkylsilanol either directly or through a hydrolysis and then reacts with a silanol group on the surface of the gel. Alternatively, if an alkylsilanol compound is used as the silylation reagent, then the compound reacts with the silanol group on the surface immediately.

Among these compounds, chlorosilane compounds and silazane compounds are particularly preferred considering their high reactivity during the hydrophobizing process step and their availability. On the other hand, alkylalkoxysilane compounds are also preferred because the compounds are also easily available and do not emit hydrogen chloride gas, ammonia gas or any other gas during the hydrophobizing process step.

Examples of preferred silylation reagents for use as the hydrophobizing agents include: chlorosilane compounds such as trimethylchlorosilane, methyltrichlorosilane and dimethyl-dichlorosilane; silazane compounds such as hexamethyl-disilazane; alkylalkoxysilane compounds such as methoxy-trimethylsilane, ethoxytrimethylsilane, dimethoxydimethyl silane, dimethoxydiethylsilane and diethoxydimethylsilane; and silanol compounds such as trimethylsilanol and triethylsilanol. When any of these silylation reagents is used as the hydrophobizing agent, an alkylsilyl group such as a trimethylsilyl group can be introduced into the surface of the wet gel, thus advancing the hydrophobizing reaction.

Also, if a fluoride silylation reagent is used as the hydrophobizing agent, then the degree of hydrophobicity can be increased very effectively.

Examples of other preferred hydrophobizing agents include alcohols such as ethanol, propanol, butanol, hexanol, heptanol, octanol, ethyleneglycol and glycerol and carboxylic acids such as formic acid, acetic acid, propionic acid and succinic acid. Each of these alcohols and carboxylic acids produces the hydrophobizing reaction by forming an ether or ester with a hydroxide group on the surface of the gel. However, such a reaction is relatively slow and should be carried out at a rather high temperature.

### Drying Process Step

The hydrophobizing process step is followed by a drying process step. In the drying process step, the solvent is removed from the wet gel that was obtained before the hydrophobizing process step, thereby obtaining a dry gel.

The solvent may be removed from the wet gel by a heat drying technique, a supercritical drying technique or a freeze drying technique. The heat drying technique is a most common and easiest drying technique. Specifically, in the heat drying technique, the wet gel including the solvent is heated, thereby vaporizing the solvent in the liquid state. Since this is a very easy method, it is most convenient to remove the solvent by this drying technique. It should be noted that the “heat drying technique” herein includes an air drying technique of drying something by leaving it in the air without heating it. This is because the air drying technique may be regarded as a technique of heating something to a very low degree so to speak. If the gel has a low density, the gel being dried may temporarily shrink and crack due to the capillary force, which is proportional to the surface tension of the solvent in the gel. For that reason, the solvent included in the gel to be dried is preferably a hydrocarbon solvent that produces a small surface tension at the boiling point. Specifically, hexane, pentane or a mixture thereof is preferably used as such a solvent because these solvents are relatively inexpensive. On the other hand, from a safety viewpoint, the solvent to be used is preferably an alcohol such as isopropanol, ethanol or butanol, water or a mixture of water and an organic solvent. In this preferred embodiment, if the wet gel can be dried by the supercritical drying technique (to be described later) into a dry gel with a pore volume of at most about 0.5 cm³/g and a specific surface of at most about 300 m³/g, then the gel will hardly shrink or crack even when dried by removing any of various solvents including alcohols and water.

In the supercritical drying technique, a supercritical fluid having a surface tension of approximately zero is used to reduce the surface tension of the solvent being removed. In this drying process, the solvent is removed without turning into a liquid. Examples of preferred supercritical fluids for use in this supercritical drying process include water, alcohols and carbon dioxide in the supercritical state. Among other things, the supercritical carbon dioxide is most preferred because the carbon dioxide achieves the supercritical state at the lowest temperature and yet is harmless to human beings.

Specifically, first, liquefied carbon dioxide is introduced into a pressure container, thereby substituting the liquefied carbon dioxide for the solvent of the wet gel in the container. Next, the pressure and the temperature are increased to above their critical points, thereby creating a supercritical state. Then, while the temperature is maintained, the carbon dioxide is released gradually to end the drying process.

On the other hand, the freeze drying technique is a drying technique in which the solvent in the wet gel is once frozen and then sublimed away. In this drying technique, the solvent does not turn into a liquid, either, and forms no gas-liquid interface in the gel. Consequently, no capillary force is created in the gel, thus minimizing the shrinkage of the gel being dried.

The solvent for use in such a freeze drying process preferably has a high vapor pressure at its freezing point. Examples of preferred solvents for use in this freeze drying process include tertiary butanol, glycerol, cyclohexane, cyclohexanol, para-xylene, benzene and phenol. Among other things, tertiary butanol and cyclcohexane are particularly preferred because vapor pressures at their freezing points are relatively high.

In the freeze drying process, it is effective to replace the solvent in the wet gel with a solvent having a high vapor pressure at its freezing point. Optionally, the solvent for use in the gelation process is also preferably such a solvent having a high vapor pressure at the freezing point. Then, the efficiency of the manufacturing process can be increased by omitting the solvent replacement from this process step.

The drying process step may be carried out either after or before the hydrophobizing process step. If the dried gel is subjected to the hydrophobizing process step, then the hydrophobic group is preferably introduced into the surface of the dry gel by exposing the dry gel to a vapor of the hydrophobizing agent, not the solution thereof. Thus, the amount of the solvent required can be decreased advantageously.

In that case, any of the various hydrophobizing agents described above may also be used. Among other things, considering their high reactivity, the chlorosilane compounds such as trimethylchlorosilane and dimethyldichlorosilane are particularly preferred. Also, if a hydrophobizing agent made of a non-chlorosilane compound is used, then it is also effective to use a catalyst that can be introduced in a gas state (e.g., ammonia and hydrogen chloride).

Also, if the hydrophobizing process step is carried out in vapor phase, then the hydrophobizing temperature can be increased without being limited by the boiling points of the solvent and the hydrophobizing agent. Accordingly, the vapor-phase hydrophobizing process step is effective in accelerating the reaction. Furthermore, if the wet gel is in the shape of a thin film or a powder, then such a vapor of the hydrophobizing agent can enter the wet gel easily. Particularly when the wet gel is a thin film, the volume of the solvent required can be reduced advantageously.

Optionally, the restructuring process step and the hydrophobizing process step may be carried out simultaneously. In that case, since these two process steps can be advanced in parallel with each other, a porous body made of a dry gel can be obtained in a shorter time.

Specifically, the restructuring/hydrophobizing process step may be carried out by immersing the wet gel, obtained by the first gelation process step, in the mixture of the restructuring gel raw material solution for use in the restructuring process step and the hydrophobizing agent. Then, the gel can be restructured and hydrophobized at the same time. In this restructuring/hydrophobizing process step, the same restructuring material and hydrophobizing agent as those described above may also be used. For example, after the first gelation process step has been carried out on an aqueous solution of silicate obtained from water glass through an electrodialysis, the resultant wet gel and an aqueous solvent, for example, may be restructured and hydrophobized simultaneously in the mixture of alkoxysilane as a gel raw material and a silazane compound as a hydrophobizing agent.

When the restructuring process step and the hydrophobizing process step are carried out in parallel in this manner, the present invention is not limited to those particular combinations of gel raw materials and hydrophobizing agents as long as a required solubility and other criteria are met. Also, if multi-functional alkylalkoxysilane, chloro-silane or alkylsilanol having an alkyl group is used as the hydrophobizing agent, then the alkyl group will be introduced into the gel skeleton and the gel will have increased flexibility and decreased brittleness. Such a gel will have a unique structure of which the core is relatively hard and the surrounding portion is relatively soft.

### Embodiment 2

Hereinafter, a method for making a dry gel according to a second specific preferred embodiment of the present invention will be described. The method of this second preferred embodiment is characterized by including no hydrophobizing process step unlike the first preferred embodiment described above but by heating and drying a hydrophobic solvent. It should be noted that the hydrophobizing process step must be carried out to minimize the shrinkage of the gel in the conventional manufacturing process of a low-density dry gel as described in Japanese Laid-Open Publication No. 7-138375 and in Journal of Non-Crystalline Solids, vol. 186, pp. 104-122, 1995.

In this preferred embodiment, a hydrophilic dry gel is obtained by performing the first gelation process step, the restructuring process step and the heat drying process step in this order. If a hydrophilic wet gel is dried by removing the hydrophobic solvent, then an increased contact angle θ will be defined between the surface of the hydrophilic porous body and the hydrophobic solvent when the hydrophobic solvent enters the dry gel. Thus, the capillary force, which is proportional to cos θ, can be reduced and the shrinkage and cracking of the dry gel can be reduced significantly compared with a hydrophobic dry gel with the same density.

As used herein, the “hydrophobic solvent” means a solvent that does not mix with water. Among other things, hydrocarbon solvents such as pentane, hexane, heptane and octane and siloxane solvents such as hexamethyldisiloxane are particularly preferred because these solvents have particularly low solubility in water and low surface tensions. To dry any of these solvents, the water in the wet gel is preferably replaced with a hydrophilic solvent such as an alcohol and then the hydrophilic solvent is preferably replaced with a hydrophobic solvent, which is a solvent for a drying process step, before the drying process step is carried out. Alternatively, the hydrophilic solvent and water are preferably removed from the wet gel by producing an azeotropic mixture in a hydrophobic solvent so as to be replaced with the hydrophobic solvent, which is a solvent for a drying process step.

Also, the more hydrophilic the surface of the wet gel, the more effectively the shrinkage can be minimized during the drying process step. Accordingly, the hydrophobic group such as an alkoxy group remaining in the wet gel is preferably turned into a hydrophilic group such as a hydroxide group through a hydrolysis. The hydrolysis of the alkoxy group can be easily carried out by immersing the wet gel in the aqueous solution of an aqueous solvent including at least about several tens volume percent of water, for example. Any aqueous solvent may be used as long as the aqueous solvent can make a uniform aqueous solution. Examples of preferred aqueous solvents include acetone, methanol, ethanol, isopropanol, and butanol. If necessary, the dried gel may be naturally hydrophobized by being exposed to a vapor of the hydrophobizing agent as described above.

It should be noted that the remaining process steps, other than the drying and hydrophobizing process steps, may be carried out as in the first preferred embodiment described above. Also, the materials to be used may be the same as the first preferred embodiment except for the solvent for a drying process step.

### Embodiment 3

Hereinafter, a method for making a dry gel according to a third specific preferred embodiment of the present invention will be described. The method of the third preferred embodiment is characterized by further including a gel strengthening process step. In the gel strengthening process step, the wet gel obtained by the restructuring process step (i.e., second wet gel) is exposed to an aqueous solution including a gelation catalyst. In this process step, the hydrolysis of the second skeleton is advanced to decrease the density of the wet gel. At the same time, however, hydroxide groups, produced by the hydrolysis, are condensed with each other, thus increasing the strength of the gel significantly. Furthermore, the gelation produced in the gel strengthening process step further increases the size of the particles that make up the second skeleton, thus thickening the neck portion between the particles and decreasing the specific surface. Accordingly, as a result of this gel strengthening process step, the neck portion is strengthened and the second skeleton of the gel has an increased overall strength. More specifically, while the neck portion is being thickened, the condensation and polymerization of the dissolved gel also advances. Consequently, the number of micropores decreases and the capillary force to be produced when the gel is immersed in, or dried from, a solvent also decreases. The present inventors confirmed by the same method that the overall volume of micropores with pore diameters of about 2 nm to about 40 nm and the specific surface were both decreased by the gel strengthening process step.

In the gel strengthening process step, the decrease in the density of the wet gel is preferably within the range of about 5% to about 30%. The reason is as follows. Specifically, if the decrease in density is less than about 5%, then the gel cannot be strengthened sufficiently. However, if the wet gel decreases its density by more than about 30%, then the strength of the wet gel will rather decrease.

In the conventional aging treatment on the other hand, when a wet gel is formed, a monomer is also left in the same mixture. Due to the presence of the monomer, the density of the wet gel does not decrease but rather increases sometimes. However, in the conventional aging treatment, the hydrolysis and the dehydration and condensation reactions do not advance as in this preferred embodiment. Thus, the gel is not strengthened due to the condensation reaction of hydroxide groups that have been produced by the hydrolysis.

To advance the hydrolysis sufficiently, the solution for use in this gel strengthening process step (i.e., the aqueous solution including the solvent but excluding the gel raw material) preferably includes at least about 20 wt % of water. Also, the concentration of the gelation catalyst is preferably relatively high, because the hydrolysis and the condensation reaction of hydroxide groups can be advanced at increased rates in that case. Any of the normal gelation catalysts mentioned above may be used as the gelation catalyst.

To dissolve an organic gelation catalyst or to strike an adequate balance between the hydrolysis and the condensation polymerization reactions by reducing the solubility of the monomer, it is sometimes necessary to include an organic solvent in the aqueous solution. Such an organic solvent is preferably an aqueous organic solvent. Examples of preferred aqueous organic solvents include monohydoric or polyhydoric lower alcohols such as methanol, ethanol, propanol, butanol, ethyleneglycol, diethyleneglycol and propyleneglycol and lower ketones or ethers such as acetone, tetrahydrofuran, dioxolane and dioxane.

Also, in the gel strengthening process step, the temperature is preferably relatively high such that the hydrolysis and the condensation polymerization reactions advance smoothly. The balance between the hydrolysis and the condensation polymerization reactions can be adjusted by adding an organic solvent as described above.

### Embodiment 4

Hereinafter, a method for making a dry gel according to a fourth specific preferred embodiment of the present invention will be described. In this fourth preferred embodiment, the restructuring process step is carried out such that only a particular surface of the first wet gel is exposed to the restructuring material solution. The respective process steps of the manufacturing process are also carried out in the same order, and using the same materials, as the first preferred embodiment described above.

By exposing only that particular surface of the first wet gel to the restructuring material solution, the resultant porous body will be made of a dry gel having a high density on the particular surface and continuously decreasing densities toward the opposite surface.

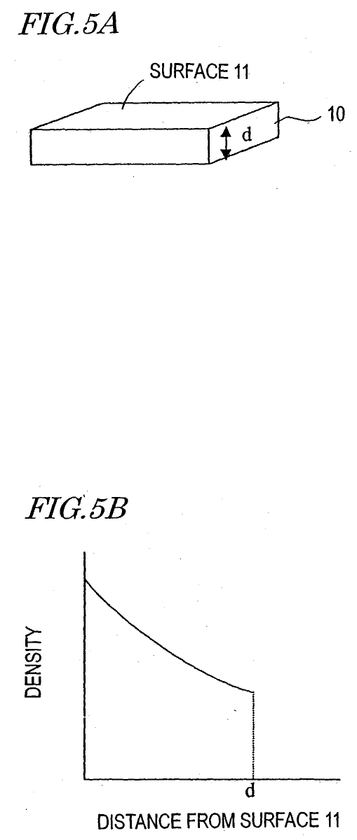

Such a porous body in the simplest form has a flat plate shape such as that shown in FIG. 5A. In that case, the restructuring process step is preferably carried out such that the surface 11 of its corresponding wet gel is exposed to the restructuring material solution while the opposite surface thereof is either in contact with the bottom of a process container or fixed to another member with no gap provided between them. Then, a block member 10, made of a gel (or porous body) of which the densities decrease continuously from the surface 11 toward the opposite surface as shown in FIG. 5B, can be obtained.

If a porous body has such a surface with an increased density, then that surface is strengthened and the porous body can be handled more easily. Also, when such a porous body is used as a material for the acoustic matching layer of an acoustic wave transceiver, the transmission and reception operations can be carried out more efficiently.

A density distribution such as that shown in FIG. 5B is formed in the restructuring process step probably due to the polymerization of monomers and oligomers in the restructuring material solution. Specifically, those monomers and oligomers, which have grown through the polymerization reaction, would reach the surface of the wet gel much earlier than the inside portion of the wet gel. And the time lag would be long enough to increase the surface density through a polymerization reaction. Accordingly, the magnitude of the density gradient is adjustable by changing the polymerization rates of the monomers and oligomers in the restructuring material solution.

### Embodiment 5

Hereinafter, a method for making a porous body according to a fifth specific preferred embodiment of the present invention will be described. In this preferred embodiment, a porous body, made of the dry gel according to any of the various preferred embodiments of the present invention described above, is in contact with, and fixed to, a base, thereby making up a composite body.

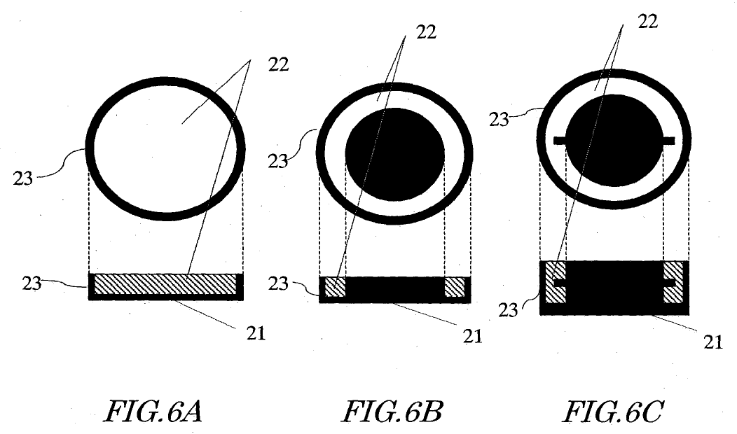

For example, in the composite body 23 shown in FIG. 6A, the opening of a base 21 is filled and combined with a porous body 22 made of a dry gel. If this porous body 22 is made of a conventional dry gel, then the porous body 22 will crack or drop off the base 21 due to the capillary force to be produced when the composite body 23 is dried after having been exposed to an organic solvent. In contrast, if the porous body 22 is made of a dry gel according to any of the various preferred embodiments of the present invention described above, then the porous body 22 will not crack even when the composite body 23 is dried. Thus, the composite body 23 including such a porous body 22 can exhibit increased solvent resistance.

On the other hand, in the composite body 23 shown in FIG. 6B, the ringlike opening of a base 21 is filled with a doughnut-shaped porous body 22 made of a dry gel. In such an arrangement, the porous body 22 shrinks and cracks much more easily when exposed to, or dried from, an organic solvent. This is because in this arrangement, a portion of the base 21 is present inside of the porous body 22 shrinking, thus placing a great stress on the porous body 22. This is why the more complex the shape of a composite body consisting of a porous body and a base, the more easily the porous body normally shrinks and cracks when exposed to, or dried from, an organic solvent. Accordingly, where a porous body made of a dry gel according to a preferred embodiment of the present invention, which hardly shrinks or cracks due to a very small number of micropores as described above, and a base are combined together to make up a composite body, the more complex the shape of the composite body, the more effectively the composite body can resist any solvent as compared with the conventional composite body.

Hereinafter, methods for making such a composite body will be described.

Two methods may be used to make a composite body such as that shown in FIG. 6A or 6B.

One of the two methods preferably includes the steps of separately preparing a porous body made of a dry gel and bonding the porous body to a base with an adhesive, for example. The other method preferably includes the steps of forming a wet gel by performing the gelation process step of the first preferred embodiment described above on a gel raw material and so on that have been poured into the opening of a base, subjecting the wet gel to the process steps described above, and then drying the wet gel processed.

The former method is easier to carry out than using a porous body made of a conventional dry gel. The reason is that the first method uses an adhesive that includes an organic solvent, for example, and that has such a low viscosity as to enter the porous body easily. In the latter method on the other hand, a porous body made of a crack-free dry gel can be obtained by a normal heat drying technique, which needs no special equipment and is much easier to perform than the freeze drying method or the supercritical drying method.

In making a composite body such as that shown in FIG. 6C, however, it is difficult to adopt the method of bonding a separately prepared porous body of a dry gel to a base because the composite body has a complex bonding shape. For that reason, such a composite body needs to be made by directly forming a wet gel in the opening of a base, subjecting the wet gel to the process steps described above, and then drying the wet gel as in the first preferred embodiment described above.

As described above, the more complex the combined shape of the porous body and the base, the more effectively the cracks can be minimized during the heat drying process. The base may be made of an organic polymer, a metal, a ceramic, a composite thereof or any other arbitrary material as long as the base can exhibit required strength when the separately prepared porous body is bonded afterward.

Alternatively, the base may also be made of foam, a porous body or a fiber aggregate. If the composite body is made by directly forming a wet gel in the opening of a base, then it is more important to increase the degree of adhesiveness of the porous body to the base. In that case, a portion of the wet gel is preferably formed in the base so as to function as an anchor. For that purpose, the base preferably includes a porous body or a fiber aggregate having a continuous pore structure. As another alternative, a chemical bond may be formed between the porous body and the base. In that case, the base is preferably made of a glass, a metal or a ceramic having a functional group that reacts with a metal-OH group (such as a silanol group) existing in the gel.

Also, the base preferably exhibits sufficient resistance against swelling caused by the restructuring material solution (i.e., second gel raw material solution) or corrosion caused by the catalyst as already described for the first preferred embodiment.

Considering the swelling resistance, the base is preferably made of an organic polymer (e.g., a fluorocarbon resin, in particular). When the base is made of a metal, the anticorrosiveness thereof may pose a problem. However, a stainless steel is preferably used against a basic catalyst such as ammonium. A ceramic material would create no serious problems when used under normal conditions. Even a material that may cause some corrosion problem could be used through a surface treatment, for example.

The composite body described above is preferably used as a heat insulator, an acoustical material, a catalyst carrier, an interlevel dielectric for an LSI, or the material of an acoustic matching layer for an ultrasonic or any other acoustic wave transceiver. Depending on the specific application, however, the composite body may further include an additional member.

### Preferred Embodiments of Porous Body

A dry gel according to a preferred embodiment of the present invention and a porous body including such a dry gel hardly shrink or crack even when exposed to, or dried from, an organic solvent. This is because the dry gel of the preferred embodiment of the present invention has a much smaller number of micropores than a conventional dry gel as described above. More specifically, the dry gel of the preferred embodiment of the present invention has an overall pore volume of at most about 1 cm³/g, which is the total volume of micropores with pore diameters of about 2 nm to about 40 nm. That is to say, a dry gel satisfying such a condition can be obtained for the first time by the preferred embodiments of the present invention described above. And when the present inventors analyzed the properties thereof, the dry gel turned out to have an overall pore volume of at most about 1 cm³/g, which is the total volume of micropores with pore diameters of about 2 nm to 40 nm, and to exhibit almost no shrinkage or cracking even when exposed to, or dried from, an organic solvent. This overall pore volume is much smaller than the overall pore volume of about 1.5 cm³/g to about 5 cm³/g of a porous body made of a conventional dry gel by a sol-gel process.

As described above, FIG. 2B schematically illustrates the structure of a porous body made of a dry gel according to a preferred embodiment of the present invention. Compared with a porous body made of a conventional dry gel such as that shown in FIG. 2A, the porous body shown in FIG. 2B has a decreased number of micropores, an increased number of relatively large pores, a thickened skeleton, and a smaller specific surface. It should be noted that the structures shown in FIGS. 2A and 2B are nothing but schematic ones. Thus, in an actual porous body, a fine structure similar to that shown in FIG. 2A may be slightly included in the structure shown in FIG. 2B.

As also described above, the dry gel according to a preferred embodiment of the present invention has a reduced number of micropores, and hardly shrinks or cracks due to the capillary force to be produced when exposed to, or dried from, an organic solvent. Thus, according to a preferred embodiment of the present invention, a dry gel, which does not crack even when heated and dried after having been immersed in n-hexane, can be obtained.

Considering the specific application thereof (as a heat insulator, an acoustical material, a catalyst carrier, an interlevel dielectric for an LSI, or the material of an acoustic matching layer for an ultrasonic or any other acoustic wave transceiver), a dry gel according to a preferred embodiment of the present invention preferably has an average density of about 50 kg m³ to about 500 kg/M³.

More specifically, according to a preferred embodiment of the present invention, a porous body, made of a dry gel with such a low density of about 50 kg/m³ to about 500 kg/m³, preferably has an overall pore volume of at most about 1 cm³/g for micropores with pore diameters of about 2 nm to about 40 nm.

As the overall pore volume decreases, the specific surface decreases, too. Specifically, a porous body made of a conventional dry gel has a specific surface of about 500 m²/g to about 1,200 m²/g. On the other hand, a porous body with a similar density according to a preferred embodiment of the present invention has a specific surface of about 250 m²/g to about 600 m²/g, which is approximately a half of the specific surface of the conventional dry gel. Thus, according to a preferred embodiment of the present invention, a dry gel having a specific surface of less than 500 m²/g, which has been hard to obtain by the conventional techniques, and a porous body including such a dry gel can be obtained.

In this manner, according to a preferred embodiment of the present invention, the number of micropores decreases and the overall pore volume also decreases, thus reducing the capillary force to be produced when the gel is exposed to an organic solvent and minimizing the shrinkage of the gel.

Also, even when a porous body made of a dry gel according to a preferred embodiment of the present invention has as low a density as about 150 kg/m³ or less, the porous body still hardly shrinks against an organic solvent. This is because the porous body has a low density and a skeleton with a low strength but has a reduced number of micropores and can reduce the capillary force to such a degree as to sustain its skeleton.

Furthermore, a porous body made of a dry gel according to a preferred embodiment of the present invention is preferably a crack-free block body with a density of about 300 kg/m to about 350 kg/m³ or more, which has been hard to obtain in the prior art.

The reason is as follows. To minimize shrinkage and cracking, it should be effective to increase the density and strengthen the skeleton as a matter of principle. However, in a porous body obtained by a conventional sol-gel process, the gel raw material thereof includes a low percentage of components to make up the skeleton of the porous body. Thus, it has been difficult to obtain a wet gel with a high density of about 300 kg/m³ to about 350 kg/M³ or more. Also, even in the conventional method of making a porous body of a dry gel, a high density gel may be obtained by allowing the gel being dried to shrink. In that case, however, it has been hard to prevent the shrinking gel from cracking. In particular, in a composite body obtained by combining the porous body with a base, if the porous body shrinks during the gelation process step or the drying process step, then the porous body would crack or drop off particularly easily. This is because only the porous body shrinks while the base maintains its sizes. Furthermore, if a composite body happens to be exposed to and dried from an organic solvent during its use, the porous body thereof may crack and drop off easily. Thus, if a porous body according to a preferred embodiment of the present invention is used as a porous body for a composite body, significant effects are achievable. A porous body made of such a dry gel is obtained by a manufacturing process according to a preferred embodiment of the present invention described above.

Furthermore, a porous body including a dry gel according to a preferred embodiment of the present invention may be made of either an inorganic material or an organic material as long as the material can form a gel. Examples of preferred organic materials include phenols, melamines, amides and other organic polymers. When the porous body is made of an inorganic material, any of various inorganic oxides, including oxides of titanium, silicon, vanadium, aluminum and zirconium, may be used.

Among other things, the porous body made of the dry gel preferably includes a silicon oxide as its main ingredient. The reason is as follows. Specifically, a silicon oxide can be obtained from an inexpensive gel raw material such as water glass and can cut down the manufacturing cost as will be described later for the manufacturing process. Also, an alkoxide of silicon has milder reactivity than an alkoxide of any other metal and its reaction is easier to control. Thus, a porous body made of such a material can also be obtained more easily.

Furthermore, in the porous body made of a dry gel according to a preferred embodiment of the present invention, the surface thereof is preferably modified with an organic silyl group. This is because the surface modified with an organic silyl group is hydrophobized. Thus, the absorption of water into the porous body can be avoided and deterioration in performance due to water absorption is also avoidable. An organic silyl group may include one, two or three organic groups. Examples of those organic groups include various alkyl groups and aryl groups. Considering its high heat resistance, the organic silyl group preferably includes a methyl group such as trimethylsilyl group or dimethylsilyl group, for example.

The porous body made of a dry gel according to a preferred embodiment of the present invention preferably has an overall pore volume of at most about 0.5 cm³/g, which is the total volume of micropores with pore diameters of about 2 nm to about 40 nm, and a specific surface of at most about 300 m²/g. The preferred average density and preferred materials thereof are as described above.

The porous body has an even smaller overall pore volume of micropores and an even smaller specific surface to be measured by a nitrogen adsorption technique, for example. Thus, when the porous body is exposed to an organic solvent, the shrinkage thereof can be minimized and the stress to be placed thereon can be reduced significantly. As a result, not only the unwanted increase in density due to shrinkage but also cracking or chipping are avoidable.

Thus, even when a block or a monolith of porous body, used as a heat insulator or as the acoustic matching layer of an ultrasonic wave transceiver, for example, is exposed to an organic solvent, deterioration in various properties thereof can be minimized.

Also, if the porous body made of the dry gel has a block shape and is bonded to another member with a liquid adhesive, then the porous body can be bonded without cracking due to the exposure to, or drying from, the adhesive.

Optionally, in a porous body made of a dry gel according to a preferred embodiment of the present invention, the skeleton thereof may have a hydrophilic surface. The hydrophilicity of the porous body can be checked by seeing if water enters the porous body made of the dry gel when the porous body is exposed to the water.

If the hydrophilic porous body is exposed to, and dried from, a hydrophobic solvent such as hydrocarbon, then the shrinkage or cracking thereof should be smaller than that of a hydrophobic porous body with the same density. This is believed to be because when the hydrophobic solvent enters the hydrophilic porous body, an increased contact angle θ is defined between the surface of the porous body and the solvent, thus reducing the capillary force, which is proportional to cos θ. Also, when the porous body is used as an adsorbent or a catalyst carrier, a substance with high polarity can be adsorbed or a catalyst with high polarity can be carried advantageously. The surface hydrophilicity is produced due to the presence of a hydrophilic group such as a hydroxide group or an amino group. For example, if a wet gel is derived from a metal alkoxide described above by a sol-gel process, then the skeleton thereof is made of a metal oxide. However, a hydroxide group, produced through the hydrolysis of the metal alkoxide, is left on the surface of the wet gel, thereby making the surface hydrophilic. Among other things, the skeleton is preferably made of a silicon oxide. The surface hydroxide group is present as a silanol group.

In a porous body made of a dry gel according to a preferred embodiment of the present invention, the density on at least one surface thereof is preferably higher than that on the other surfaces. In that case, even if the average density remains the same, the density can be increased on one particular surface. Thus, a sufficient strength can be ensured on the surface that should be as strong as possible, and the porous body can be handled easily. Even so, the average density and the materials used may be the same as those described above.

For example, such a porous body may be the flat plate block member 10 shown in FIG. 5A (as described for the fourth preferred embodiment). As shown in FIG. 5B, this block member 10 has densities that change continuously in the thickness d direction, and the density of the block member 10 is the highest on the surface 11. If this block member 10 is arranged such that the surface 11 having the highest density and ensuring sufficient strength faces outward, then damage to be done on the surface 11 can be minimized.

Also, such a porous body, made of a dry gel of which the density decreases continuously from one surface toward the other as in the block member 10 shown in FIGS. 5A and 5B, can be used effectively as a material for the acoustic matching layer of an ultrasonic wave transceiver, for example. The acoustic matching layer is provided between a member with a relatively high acoustic resistance and a member with a relatively low acoustic resistance to match those acoustic resistances with each other. Thus, if the acoustic matching layer is made of such a porous body, then the resultant acoustic resistance of the matching layer will gradually change from a relatively high value corresponding to the high density to a relatively low value corresponding to the low density. As a result, an acoustic wave can be transmitted or received through such a layer more efficiently.

In the example shown in FIG. 5B, the density is supposed to be high on just one surface. Alternatively, another porous body may have a high density on the upper and lower surfaces thereof and low densities in the intermediate portion thereof. In that case, both of these surfaces can have their strength increased because those surfaces may contact with external members.

Hereinafter, specific examples of preferred embodiments of the present invention will be described. It should be noted, however, that the present invention is not necessarily limited to the types and quantities of gel raw materials, gelation catalysts and other materials to be described below.

### EXAMPLES

### Example No. 1 and Comparative Example No. 1

### Example No. 1

In a first specific example of a preferred embodiment of the present invention, a first wet gel was prepared by using an aqueous solution of silicate, which had been made from water glass by electrodialysis, as a first gel raw material. Next, the first wet gel was subjected to a restructuring process step by using tetraethoxysilane as a restructuring material (i.e., second gel raw material). Thereafter, the resultant wet gel was subjected to a hydrophobizing process step and a drying process step, thereby obtaining a porous body of a dry gel.

More specifically, the first gelation process step was carried out in the following manner. First, the pH of a silicate aqueous solution including about 9 wt % of SiO₂ and about 0.6 wt % of Na₂O was adjusted to about 6 to about 8 by adding 2N sulfuric acid to the aqueous solution, thereby advancing a gelation reaction and forming the first skeleton of a first wet gel.

Subsequently, the wet gel was immersed in 0.2N acetic acid, thereby turning sodium remaining in the wet gel into sodium acetate. Then, the wet gel was further washed with ion exchange water, thereby removing most of the sodium acetate and sodium sulfate that was produced during the first gelation process step.

Next, the restructuring process step (i.e., second gelation process step) was carried out by immersing the wet gel, which had been obtained by the first gelation process step, in a solution including a mixture of tetraethoxysilane and isopropanol and 0.1N ammonia water at room temperature for approximately 16 hours. In the mixture, tetraethoxysilane and isopropanol were mixed at a volume ratio of approximately 4 to 1. And the mixture and the ammonia water were mixed at a volume ratio of approximately 95 to 5.

Subsequently, the resultant wet gel was immersed in acetone, thereby substituting acetone for the solvent included in the wet gel. Thereafter, the wet gel was subjected to a hydrophobizing process at room temperature for approximately one day by adding trimethylchlorosilane to the wet gel. The concentration of trimethylchlorosilane added was about 10 vol % with respect to acetone.

Next, the hydrophobized gel was put into a pressure container and liquefied carbon dioxide was supplied into the container, thereby substituting liquefied carbon dioxide for the solvent in the gel. Also, the liquefied carbon dioxide was further pumped into the container to increase the pressure inside the container to about 10 MPa. Thereafter, the temperature was increased to about 50° C., thereby creating a supercritical state inside the container. Finally, while the temperature was maintained at about 50° C., the pressure was decreased slowly, thereby completing a drying process.

### Comparative Example No. 1

In a first comparative example, a wet gel was prepared by performing the first gelation process step as in the first specific example described above. Next, the wet gel was immersed in isopropanol, thereby substituting isopropanol for the water in the gel. Thereafter, the wet gel was immersed in a mixture of tetraethoxysilane and isopropanol (at a volume ratio of approximately 4 to 1) at about 80° C. for approximately 6 days. That is to say, in the first comparative example, the wet gel was immersed in the solution including the gel raw material and the solvent without adding any water or catalyst thereto as opposed to the restructuring process step of the first specific example.

A porous body made of the dry gel of the first specific example had a density of about 210 kg/m³, while a porous body made of the dry gel of the first comparative example had a density of about 220 kg/m³. These two porous bodies were immersed in n-hexane, dried, and then had their variations in density compared with each other. As a result, the porous body made of the dry gel of the first specific example showed a smaller variation in density than the porous body made of the dry gel of the first comparative example. Specifically, after having been immersed in n-hexane and dried, the porous body of the first specific example had a density of about 210 kg/M³ while the porous body of the first comparative example had a density of about 260 kg/m^{3.}

In this manner, a porous body, which hardly changed its density and hardly shrunk (exhibited almost no variation in density and almost no shrinkage), could be obtained in the first specific example. This is believed to be because the water and catalyst added should have polymerized the monomer and decomposed and restructured the first skeleton efficiently enough.

### Example No. 2 and Comparative Example Nos. 2 and 3

### Example No. 2

In a second specific example of a preferred embodiment of the present invention, a porous body made of a dry gel was obtained by performing the first gelation process step, restructuring process step, hydrophobizing process step and drying process step. Then, the porous body was tested for any variations through the contact with an organic solvent.

### First Gelation Process Step

First, tetraethoxysilane, ethanol, water and hydrogen chloride were mixed together at a mole ratio of approximately 1 to 15 to 1 to 0.00078, and the mixture was left in a thermostat at a temperature about 65° C. for approximately 3 hours, thereby advancing the hydrolysis of tetraethoxysilane. Next, water and NH₃ were further added to the mixture at a mole ratio of approximately 2.5 to 0.0057 with respect to tetraethoxysilane, and then the resultant mixture was left in a thermostat at a temperature of about 50° C. for approximately one day, thereby advancing the gelation and obtaining a wet gel. At this point in time, the wet gel was cut into pieces with approximate dimensions of 10 mm×10 mm×3 mm.

### Restructuring Process Step

Tetraethoxysilane was used as a restructuring material (i.e., second gel raw material) and ammonia water was used as a restructuring catalyst (i.e., second catalyst). The wet gel, which had been obtained by the first gelation process step, was immersed in a restructuring material solution (i.e., second gel raw material solution) obtained by mixing tetraethoxysilane, ethanol and ammonia water at a volume ratio of approximately 60 to 35 to 5 and processed in a thermostat at a temperature of about 70° C. The restructuring process was carried out four times separately for approximately 9 hours, approximately 10.5 hours, approximately 13 hours and approximately 24 hours, respectively. The ammonia water used was O.1N and the volume of the restructuring material solution used was approximately 20 times as large as that of the wet gel.

### Hydrophobizing Process Step

The wet gel obtained by the restructuring process step was immersed in isopropylalcohol, of which the volume was approximately 5 times as large as that of the gel, and cleaned twice. Then, the wet gel was hydrophobized in a hydrophobizing solution, obtained by mixing together dimethyldimethoxysilane, isopropylalcohol and ammonia water at a weight ratio of approximately 45 to 45 to 10, at about 40° C. for approximately one day with the mixture stirred up. The volume of the hydrophobizing solution used was approximately 20 times as large as that of the wet gel.

### Drying Process Step

Subsequently, the hydrophobized gel was immersed in isopropylalcohol, of which the volume was approximately five times as large as that of the gel, and cleaned twice. Next, the hydrophobized gel was put into a pressure container and liquefied carbon dioxide was supplied into the container, thereby substituting liquefied carbon dioxide for the isopropylalcohol in the gel. Also, the liquefied carbon dioxide was further pumped into the container to increase the pressure inside the container to about 10 MPa. Thereafter, the temperature was increased to about 50° C., thereby creating a supercritical state inside the container. Finally, while the temperature was maintained at about 50° C., the pressure was decreased slowly, thereby completing the drying process.

### Solvent Resistance Test

The density, the overall volume of pores with pore diameters of about 2 nm to about 40 nm and the specific surface of the resultant dry gel were measured. The density was obtained by weighing the dry gel and by calculating its volume from the buoyancy of the dry gel that was immersed in water. The volume of the micropores and the specific surface were calculated by applying a BJH method and a BET method to a nitrogen adsorption process.

As a result, the dry gel that had been subjected to the restructuring process step for approximately 9 hours had a density of about 150 kg/m³, an overall pore volume of about 0.9 cm³/g and a specific surface of about 390 m²/g. The dry gel that had been subjected to the restructuring process step for approximately 10.5 hours had a density of about 190 kg /m³, an overall pore volume of about 0.7 cm³/g and a specific surface of about 340 m2/g. The dry gel that had been subjected to the restructuring process step for approximately 13 hours had a density of about 250 kg/m³, an overall pore volume of about 0.5 cm³/g and a specific surface of about 270 m²/g. And the dry gel that had been subjected to the restructuring process step for approximately 24 hours had a density of about 420 kg/m³, an overall pore volume of about 0.3 cm³/g and a specific surface of about 180 m²/g.

These four dry gels were subjected to a solvent resistance test by using n-hexane as an organic solvent. Specifically, the dry gels were immersed in n-hexane and then dried in the air. The dry gels that had been subjected to the restructuring process steps for approximately 9 hours and. approximately 10.5 hours showed no increase in density due to shrinkage but cracked when dried. On the other hand, the dry gels that had been subjected to the restructuring process step for approximately 13 hours and approximately 24 hours showed no increase in density or cracking.

### Comparative Example No. 2

For the purpose of comparison, the wet gel, obtained by the first gelation process step of the second specific example described above, was subjected to the same hydrophobizing and drying process steps as in the second specific example, thereby obtaining a dry gel. The density, the overall pore volume and the specific surface of the dry gel, which were measured by the same methods as those adopted for the second specific example, were about 81 kg/M³, about 3.0 cm³/g and about 270 m²/g, respectively. When the dry gel was subjected to the same solvent resistance test, the dry gel decreased its sizes by more than about 20% and cracked into multiple pieces.

### Comparative Example No. 3

Furthermore, to obtain a gel with a high initial density as a sample indicating how much shrinkage can be reduced in a dry gel prepared by a conventional sol-gel process, tetraethoxysilane, ethanol and water were mixed together at a mole ratio of approximately 1 to 1 to 4 and at a mole ratio of approximately 1 to 5 to 4, thereby advancing the gelation reaction at room temperature. In this process step, water was added and mixed as 0.1N ammonia water. Thereafter, a dry gel was obtained as in the second comparative example described above, and the respective properties thereof were measured.

The density, the overall pore volume and the specific surface of the former dry gel were about 170 kg/m³, about 2.9 cm³/g and about 550 m²/g, respectively. The density, the overall pore volume and the specific surface of the latter dry gel were about 280 kg/m³, about 2.7 cm³/g and about 510 m²/g, respectively. When these two dry gels were subjected to the same solvent resistance test, the dry gel with the density of about 170 kg/m³ increased its density more than twofold due to shrinkage and cracked into fine pieces. On the other hand, the dry gel with the density of about 280 kg/m³ increased its density to about 290 kg/m³ and also cracked at many points.

Thus, the present inventors discovered that a dry gel with a reduced number of micropores according to a preferred embodiment of the present invention exhibited higher solvent resistance than a conventional dry gel with the same density. Specifically, the present inventors confirmed that the shrinkage of the dry gel could be reduced significantly and that not only the shrinkage but also cracking could be minimized in a dry gel with an even smaller overall volume of micropores. This is believed to be because the decrease in the number of those micropores reduced the capillary force when the dry gel was immersed in, or dried from, the solvent.

### Example No. 3

In a third specific example of a preferred embodiment of the present invention, a porous body made of a dry gel was also obtained by performing the first gelation process step, restructuring process step, hydrophobizing process step and drying process step. In this specific example, to increase the surface strength of the dry gel, just one surface of the wet gel was exposed to the restructuring material solution (i.e., the second gel raw material solution) in the restructuring process step.

In the first gelation process step, a wet gel was formed in a jig that was made of PTFE (e.g., Teflon™) and that had an opening with approximate dimensions of 30 mm×15 mm×3 mm (depth). Thereafter, the wet gel, still contained in the jig, was subjected to the restructuring process step such that just the top of the plate-shaped wet gel was exposed to the restructuring material solution. The restructuring process step was carried out for approximately 24 hours. In the other respects, a dry gel was prepared as in the second specific example described above.

The average density, the overall volume of micropores, and the specific surface of the resultant dry gel were obtained as in the second specific example described above. These values were calculated as averages for the overall dry gel. As a result, the density was about 330 kg/m³, the overall pore volume was about 0.45 cm³/g and the specific surface was about 230 m²/g. This dry gel was also subjected to the same solvent resistance test as that carried out for the second specific example. However, no shrinkage or cracking was observed in this dry gel.

Furthermore, three portions of the dry gel, which were defined by the depth as measured from the surface that had been in contact with the restructuring material solution during the restructuring process step, had their densities measured. As a result, the shallowest portion with a depth of about 0 mm to about 1 mm had a density of about 450 kg/M³, the intermediate portion with a depth of about 1 mm to about 2 mm had a density of about 330 kg/M³ and the deepest portion with a depth of about 2 mm to about 3 mm had a density of about 230 kg/m³.

Also, when the surface of the dry gel with the relatively high density and the opposite surface thereof with the relatively low density were faced with each other and pressed against each other, the surface with the relatively low density deformed earlier than the surface with the relatively high density.

In this manner, when just one surface of the wet gel was exposed to the restructuring material solution during the restructuring process step, a porous body could be made of a dry gel with a high surface density and a high surface strength.

### Example No. 4

In a fourth specific example of a preferred embodiment of the present invention, a dry gel was obtained by performing the first gelation process step, restructuring process step, hydrophobizing process step and heat drying process step.

One of the four types of wet gels of the second specific example, which had been subjected to the restructuring process step for approximately 24 hours, was hydrophobized and then isopropylalcohol, having approximately five times as large a volume as the gel, was substituted. Meanwhile, a portion of the same type of wet gel was replaced with n-hexane by a similar method. Thereafter, these two wet gels were heated and dried in an atmosphere at about 35° C.

The densities, overall pore volumes and specific surfaces of the resultant dry gels were measured as in the second specific example. The dry gel obtained by drying the wet gel from isopropylalcohol had a density of about 250 kg/m³, an overall pore volume of about 0.5 cm³/g and a specific surface of about 280 m²/g. On the other hand, the dry gel obtained by drying the wet gel from n-hexane had a density of about 250 kg/m³, an overall pore volume of about 0.49 cm³/g and a specific surface of about 270 m²/g. These values were similar to those of the dry gel of the second specific example that was obtained by the supercritical drying technique. Also, no cracking was observed in a porous body made of such a dry gel.

Thus, the present inventors confirmed that if a wet gel was prepared by the manufacturing process according to a preferred embodiment of the present invention, a porous body could be made of a dry gel with no shrinkage or cracking. This is believed to be because the decrease in the number of micropores in the porous body reduced the capillary force to be produced during the drying process step.

### Example No. 5

In a fifth specific example of a preferred embodiment of the present invention, a dry gel was obtained by heating and drying a wet gel from a hydrophobic solvent without performing the hydrophobizing process step after the first gelation process step and the restructuring process step.

One of the four types of wet gels of the second specific example, which had been subjected to the restructuring process step for approximately 10.5 hours, was subjected twice to the same substituting process step using a mixture of isopropylalcohol and water that were mixed together at a weight ratio of approximately 50 to 50 and that had approximately five times as large a volume as the wet gel. The resultant mixture was left in an atmosphere at about 70° C. for approximately one day. Subsequently, the wet gel was twice immersed in, and replaced with, isopropylalcohol that also had approximately five times as large a volume as the wet gel. Furthermore, isopropanol in the wet gel was replaced with isooctane by a similar method. Finally, the resultant wet gel was heated and dried in an atmosphere at about 35° C. The physical properties of the dry gel obtained in this manner were measured as in the second specific example. As a result, the dry gel had a density of about 190 kg/m³, an overall pore volume of about 0.9 cm³/g, and a specific surface of about 380 m²/g, which were similar to those of the dry gel of the second specific example that was obtained by the supercritical drying technique. Unlike the second specific example, no cracking was observed in a porous body made of such a dry gel.

Thus, the present inventors confirmed that when a dry gel was obtained by directly drying the wet gel from the hydrophobic solvent without performing the hydrophobizing process step, cracking of the dry gel could be reduced as compared with the dry gel that had been subjected to the hydrophobizing process step. This is believed to be because the capillary force to be produced between the surface of the hydrophilc gel and the hydrophobic solvent was smaller than the capillary force to be produced between the surface of the hydrophobic gel and the hydrophobic solvent.

### Example No. 6 and Comparative Example No. 4

### Example No. 6

In a sixth specific example of a preferred embodiment of the present invention, a composite body was obtained by combining a porous body made of a dry gel (that had been dried by a heat drying technique) with a base and then tested for its solvent resistance.

The base was formed in the shape shown in FIG. 6A. In this specific example, a Pyrex™ base, having a diameter of about 20 mm, a height of about 7 mm and a thickness of about 2 mm, was used. In the first gelation process step, a mixture including the gel raw material was poured into the base and then closed airtight with a lid of a fluorocarbon, thereby making a wet gel. The lid was removed before the restructuring process step was started, and then the restructuring and hydrophobizing process steps were carried out. The respective process steps were carried out under the same conditions as the second specific example described above, except that the restructuring process step was performed for approximately 13 hours. Subsequently, the wet gel was twice immersed in, and replaced with, isopropylalcohol having approximately five times as large a volume as the wet gel. Thereafter, isopropanol in the wet gel was replaced with n-hexane by a similar method. Finally, the resultant wet gel was heated and dried in an atmosphere at about 35° C. Then, the porous body was cut out of the composite body and the physical properties thereof were measured as in the second specific example. As a result, the porous body had a density of about 255 kg/m³, an overall pore volume of about 0.49 cm³/g and a specific surface of about 250 m²/g, which were similar to those of the dry gel of the second specific example that was obtained by the supercritical drying technique. Also, before cut out of the composite body, the porous body showed no cracking. A comparative composite body, which was prepared simultaneously with the composite body under test for physical properties, was subjected to the same solvent resistance test as in the second specific example. As a result, no cracking was observed in the porous body of either composite body. Also, the porous body, cut out of the composite body, substantially maintained their physical properties even after the test.

### Comparative Example No. 4

For the purpose of comparison, a hydrophobized wet gel was formed in a base as in the sixth specific example described above by using a mixture including tetraethoxysilane, ethanol and water at a mole ratio of approximately 1 to 1 to 4 as in the second comparative example described above. Then, the wet gel was heated and dried from n-hexane as in the sixth specific example. The dried porous body in the composite body cracked and a portion of the porous body dropped off the base.

Thus, the present inventors confirmed that if the porous body in the composite body had a reduced number of micropores, the porous body being dried hardly cracked or dropped off the base, could be processed by the heat drying technique, and could exhibit increased solvent resistance. This is believed to be because the decrease in the number of micropores in the porous body reduced the capillary force.

### Example No. 7

In a seventh specific example of a preferred embodiment of the present invention, a dry gel was obtained by performing a gel strengthening process step after the first gelation process step and the restructuring (i.e., second gelation) process step.

In the first gelation process step, two wet gels, having approximate dimensions of 30 mm×15 mm×3 mm, were prepared as in the third specific example described above. Then, the wet gels were subjected to the restructuring process step as in the third specific example.

One of these two wet gels was processed as in the third specific example into a dry gel. The other wet gel was subjected to a gel strengthening process step by immersing it in a mixture including 2N ammonia water and isopropanol at a weight ratio of approximately 50 to 50. Thereafter, the wet gel was also processed as in the third specific example into another dry gel. The gel strengthening process step was carried out for approximately 24 hours by using a solution having approximately 20 times as large a volume as the wet gel.

Thereafter, the physical properties of the two dry gels obtained were measured as in the second specific example. As a result, the dry gel that had not been subjected to the gel strengthening process step had a density of about 330 kg/m³, an overall pore volume of about 0.45 cm³/g, and a specific surface of about 240 m²/g. On the other hand, the dry gel that had been subjected to the gel strengthening process step had a density of about 300 kg/m³, an overall pore volume of about 0.35 cm³/g, and a specific surface of about 170 m²/g. No cracking was observed in any of the resultant porous bodies.

Then, the two dry gels were subjected to the solvent resistance test as in the first specific example described above, except that isopropanol was used as a solvent and the gels were dried at about 50° C. As a result, none of the two dry gels shrank or cracked.

Furthermore, these two dry gels were arranged such that the surfaces of the two dry gels that had been in contact with the restructuring material solution in the restructuring process step were opposed to each other, and then pressed against each other until one of the two dry gels was deformed. As a result, the dry gel that had not been subjected to the gel strengthening process step deformed and cracked earlier than the dry gel that had been subjected to the gel strengthening process step.

Thus, the present inventors confirmed that if a dry gel was subjected to the gel strengthening process step, the density of the dry gel decreased but the strength thereof increased. This is believed to be because the neck portion between particles of the dry gel could be thickened, and the number of micropores could be reduced, by performing the gel strengthening process step. The decreases in the specific surface and in the overall pore volume were also confirmed.

In the specific examples of preferred embodiments of the present invention described above, the wet gel is subjected to the restructuring process step without being dried. However, the present invention is in no way limited to these specific examples. A low-density wet gel may crack while being dried. However, if the dry gel is supposed to be used as a powder (including granules) eventually, the wet gel may be dried once and then subjected to the restructuring process step. As already described for the specific examples, even a low-density gel will not increase its density excessively or crack due to the collapse of its skeleton once subjected to the restructuring process step. As a result, a block of low-density dry gel, which could not be formed by any conventional manufacturing process, can be obtained.

Also, a porous body according to any of various preferred embodiments of the present invention described above is made of a dry gel. However, the porous body does not have to consist of the dry gel alone. Alternatively, the porous body may be a mixture of the dry gel according to a preferred embodiment of the present invention and a conventional dry gel or a binder or filler (short fibers). Such a porous body as a mixture of the dry gel and a binder or filler may be produced by a known method (see Japanese Patent Publication No. 10-508049, for example) and the description thereof will be omitted herein.

A porous body made of a dry gel according to any of various preferred embodiments of the present invention described above has an overall pore volume of at most about 1 cm³/g, which is the total volume of micropores with pore diameters of about 2 nm to about 40 nm. Thus, the porous body hardly shrinks even when exposed to an organic solvent.

Also, a porous body made of a dry gel according to a preferred embodiment of the present invention preferably has an overall pore volume of at most about 0.5 cm³/g, which is the total volume of micropores with pore diameters of about 2 nm to about 40 nm, and a specific surface of at most about 300 m³/g. Thus, such a porous body never shrinks or cracks even when exposed to an organic solvent.

Furthermore, a porous body made of a dry gel according to another preferred embodiment of the present invention preferably has a hydrophilic surface, thus carrying any of various substances thereon more easily and exhibiting increased resistance against a hydrophobic solvent.

Furthermore, a porous body made of a dry gel according to still another preferred embodiment of the present invention preferably has a density distribution in which the densities decrease continuously from the surface thereof. Since such a porous body can have its surface density changed selectively, a minimum required strength for handling can be easily ensured.

A method for making a porous body including a dry gel according to a preferred embodiment of the present invention preferably includes a first gelation process step and a restructuring process step. The restructuring process step is preferably carried out by using a restructuring material solution that includes a restructuring material, a restructuring catalyst and water. In this method, the microporous structure can be restructured significantly and a porous body, made of a dry gel having a reduced number of micropores with pore diameters of about 2 nm to about 40 nm, can be obtained easily.

Another method for making a porous body including a dry gel according to another preferred embodiment of the present invention preferably also includes a first gelation process step and a restructuring process step. The restructuring process step is preferably carried out by using a restructuring material solution that includes a restructuring material, a restructuring catalyst and water. Also, in this method, the wet gel is directly heated and dried from a hydrophobic solvent without being subjected to the hydrophobizing process step. Thus, a porous body, made of a dry gel having an even lower density and hydrophilicity that is high enough to avoid shrinkage or cracking, can be obtained easily.

Furthermore, in another method for making a porous body including a dry gel according to another preferred embodiment of the present invention, a particular surface of the wet gel is selectively exposed to the restructuring material solution in the restructuring process step. Thus, a porous body, made of a dry gel of which the densities decrease continuously from the particular surface, can be obtained easily.

Furthermore, a composite body according to a preferred embodiment of the present invention preferably has an overall pore volume of at most about 0.5 cm³/g, which is the total volume of micropores having pore diameters of about 2 nm to about 40 nm, and is preferably obtained by combining a porous body made of the dry gel with a base. Thus, the composite body can exhibit increased solvent resistance and can be obtained by a heat drying technique. Consequently, by using such a composite body as a heat insulator, an acoustical material, a catalyst carrier, an interlevel dielectric for an LSI or a material for the acoustic matching layer of an ultrasonic or any other acoustic wave transceiver, these materials can be provided more easily with their reliability increased significantly.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

1. A method of making a porous body including a dry gel, the method comprising the step of forming the dry gel,
wherein the step of forming the dry gel includes the steps of:
preparing a first gel having a first skeleton and pores; and
restructuring the first gel by decomposing at least a portion of the first skeleton and forming a second skeleton, which is thicker than the first skeleton.

2. The method of claim 1, wherein the step of restructuring includes the step of exposing the first gel to a restructuring material solution that produces particles with particle sizes of about 10 nm to about 100 nm.

3. The method of claim 1, wherein the step of preparing the first gel includes the step of deriving a first wet gel from a first gel raw material solution by a sol-gel process, the first gel raw material solution including a first gel raw material, a first catalyst and a first solvent.

4. The method of claim 3, wherein the step of restructuring includes the step of exposing the first wet gel to a restructuring material solution, which includes a restructuring material, a restructuring catalyst, water and a restructuring solvent.

5. The method of claim 4, wherein the step of restructuring includes the step of producing particles with particle sizes of about 10 nm to about 100 nm in the restructuring material solution.

6. The method of claim 1, further comprising the step of decomposing a portion of the second skeleton and strengthening the second skeleton by exposing a second wet gel, produced by the restructuring step, to an aqueous solution including another catalyst.

7. The method of claim 1, further comprising the step of hydrophobizing the surface of the second skeleton.

8. The method of claim 7, wherein the step of hydrophobizing the surface of the second skeleton and the step of restructuring are carried out in parallel with each other.

9. The method of claim 1, wherein the step of forming the dry gel includes the step of forming a hydrophilic dry gel.

10. A porous body made by a method of making a porous body including a dry gel, the method comprising the step of forming the dry gel,
wherein the step of forming the dry gel includes the steps of:
preparing a first gel having a first skeleton and pores; and
restructuring the first gel by decomposing at least a portion of the first skeleton and forming a second skeleton, which is thicker than the first skeleton.

11. The porous body of claim 10, wherein the dry gel has a skeleton and pores, the pores including a first group of pores with pore diameters of about 2 nm to about 40 nm, the first group of pores having a volume of at most about 1 cm³/g.

12. A porous body including a dry gel having a skeleton and pores, wherein the pores include a first group of pores with pore diameters of about 2 nm to about 40 nm, and the first group of pores have a volume of at most about 1 cm³/g.

13. The porous body of claim 12, wherein the dry gel has the first group of pores with a volume of at most about 0.5 cm³/g and with a specific surface of at most about 300 m²/g.

14. The porous body of claim 12, wherein the surface of the skeleton is hydrophilic.

15. The porous body of claim 12, wherein at least one surface portion of the porous body has a higher density than the other surface portions thereof.

16. The porous body of claim 12, wherein the dry gel has an average density of about 50 kg/m³ to about 500 kg/m³.

17. The porous body of claim 12, wherein the skeleton of the dry gel is made of an inorganic material.

18. The porous body of claim 17, wherein the inorganic material includes an inorganic oxide.

19. The porous body of claim 10, wherein the dry gel does not crack even when heated and dried after having been immersed in n-hexane.

20. A composite body comprising a base and a porous body layer provided on the base, wherein the porous body layer includes a porous body including a dry gel having a skeleton and pores, wherein the pores include a first group of pores with pore diameters of about 2 nm to about 40 nm, and the first group of pores have a volume of at most about 1 cm³/g.

21. A gel raw material solution for use as the restructuring material solution of claim 2, the gel raw material solution including a gel raw material, a catalyst, water and a solvent.
